(19) United States
(12) Patent Application Publication
(10) Pub. No.: US 2004/0087310 A1
(43) Pub. Date: May 6, 2004

(54) Allocation of communications frequency spectrum

(76) Inventors: Matthew Murray Williamson, Bishopston (GB); James Thomas Edward McDonnell, Gardens (GB); John Deryk Waters, Combe Down Bath (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/629,844

(22) Filed: Jul. 30, 2003

(30) Foreign Application Priority Data
Jul. 31, 2002 (GB) 0217829.9

(51) Int. Cl. H04Q 7/20; H04B 7/00

(52) U.S. Cl. 455/450; 455/509; 455/446

(57) ABSTRACT

A method of monitoring frequency availability for a telecommunications network includes: establishing details of frequency spectrum usage in a database, said details to include one or more of time of use, frequency and geographic area of use; and providing query means for the database, to allow the contents of the database to be queried.

### FIELD OF THE INVENTION

This invention relates to allocation of communications frequency spectrum. In particular aspects, it relates to a method of monitoring frequency availability across a communications frequency spectrum and to a system for achieving the same, such a method and system being extendable to include re-utilising frequency availability.

### BACKGROUND OF THE INVENTION

The use of the radio spectrum for communications is typically controlled by governments and generally Bold or licensed to various operators. The licences are generally static agreements, giving the operators the right to use different parts of the spectrum in different, specified, geographical areas. However, due to the geographical extent, the roll out of new base station infrastructure and the density of population some areas will not have the full spectrum in use at all times.

A problem arises in this respect because it is hard to reuse, re-sell or exploit the remaining spectrum, because it is unclear which parts are available at which times and in which geographical areas.

### SUMMARY OF THE INVENTION

According to a first aspect of the present invention a method of monitoring frequency availability for a telecommunications network includes: establishing details of frequency spectrum usage in a database, said details to include one or more of time of use, frequency and geographic area of use; and providing query means for the database, to allow the contents of the database to be queried.

The details of spectrum usage may additionally include one or more of ownership details of a particular part of the spectrum, licence-holder details of a particular part of the spectrum, planning rules relating to a particular part of the spectrum, a price or prices relating to a particular part of the spectrum. Said particular part of the spectrum may be a part by frequency, a part by geographic area and/or a part by time of use.

The database is preferably a relational database.

The database is preferably updated by means of a website interface. The database may be updated by editing a local copy of the file, preferably using the relational database program.

The query means may comprise a user interface, which preferably allows a user to enter search terms relating to frequency availability, said search terms may be the variables used in the details of spectrum usage. The query means is preferably operable to return details of spectrum availability based on the search terms entered.

The method of monitoring preferably extends to include a method of re-utilising frequency availability. The method preferably involves offering frequency availability for subsequent use.

The frequency availability may be resold, for example by auction. The database may be run and availability resold by a party independent to one or more frequency owners/licence holders.

The method may extend to enforcement of spectrum usage, whereby the use of resold frequency availability is monitored. The monitoring may be by means of frequency detectors, which may travel through chosen geographical areas to monitor frequency usage.

The details of spectrum usage may be entered as details of frequency in use (i.e. positive details) or as details of frequency not in use (i.e. negative details). In any event whether details of use or non-use are entered into the database frequency capacity can be determined.

According to a second aspect of the invention a system for monitoring frequency availability comprises a database containing details of frequency spectrum usage, including at least one of time of use, frequency and geographic area of use; and

database query means, operable to allow details of frequency spectrum usage to be entered and operable to return frequency availability for said entered details of frequency spectrum usage.

The system may also comprise available spectrum purchasing means, preferably operable to allow purchase, re-licensing or re-selling of available frequency spectrum.

The system may also comprise frequency usage monitoring means, which may incorporate at least one frequency usage detector.

The invention extends to a computer programmed to perform the method of the first aspect.

According to a third aspect of the invention; a method of monitoring frequency availability for a telecommunications network includes: establishing details of frequency spectrum usage in a database, said details to include one or more of time of use, frequency and geographic area of use; and providing query means for the database, to allow the contents of the database to be queried, in which the details of the spectrum usage additionally include one or more of ownership details of a particular part of the spectrum, licence-holder details of a particular part of the spectrum, planning rules relating to a particular part of the spectrum, a price or prices relating to a particular part of the spectrum, and in which said particular part of the spectrum is a part by frequency, a part by geographic area and/or a part by time of use.

According to the fourth aspect of the invention, a method of providing information concerning frequency availability for a telecommunications network comprises consulting a database of frequency spectrum usage in response to an enquiry from an enquirer and advising the enquirer of frequency availability relating to the enquiry. preferably in which the database consulted is the database of the first aspect.

According to a fifth aspect of the invention, a method of constructing a database of frequency availability for a telecommunications network comprises obtaining information of frequency spectrum usage, said information including one or mare of time of use, frequency and geographic area of use; and entering said information into a database.

According t a sixth aspect of the invention, a method of brokering frequency availability for a telecommunications network comprises providing information concerning frequency availability on a telecommunications network to a potential purchaser; agreeing a price for the sale/licensing of the frequency availability; and selling/licensing said frequency availability.

Preferably, the information concerning frequency availability is obtained from a database as described in the first aspect.

All of the features disclosed herein may be combined with any of the above aspects, in any combination.

### BRIEF DESCRIPTION OF THE DRAWINGS

For a better understanding of the invention and to show how the same may be brought into effect, a specific embodiment will now be described by way of example with reference to the accompanying drawings, in which:

FIG. 1 is a schematic flow diagram showing the preparation and use of a dynamic database of spectrum usage and reuse of available frequencies; and

FIG. 2 is a schematic diagram of a frequency monitoring system.

### DESCRIPTION OF PREFERRED EMBODIMENTS

The way in which different parts of the radio spectrum for telecommunications use is partitioned between different operators and how that spectrum is used is not recorded in a searchable manner. Different geographical areas have different levels of use of different parts of the radio spectrum, because of differences in speed of rollout of base station infrastructure and because of the density of population and also population movements on daily timescales and on longer timescales. In view of this there is spectrum availability which at present is not managed or catalogued in any useful way.

A solution to the problem is to create a database of spectrum usage. The database is indexed by a variety of relevant variables, which may include a time period during which a particular part of the spectrum is in use, a particular geographical area in which a given part of the spectrum is in use, a frequency in use, details of the owner/licensee of the particular frequency and geographical area, planning rules/regulations relating to a particular frequency or geographical area, prices for reuse of a particular part of the spectrum in a given area for a given time or for another specified variable.

An alternative formulation for the database would be to include information as when parts of the spectrum are not in use, rather than those parts which are in use as mentioned above.

The database is implemented using a relational database, which for example, may be an Oracle database.

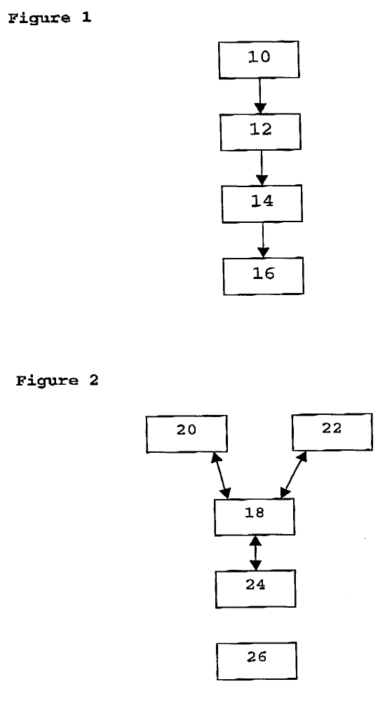

FIG. 1 shows a flow diagram of how the database may be built up and utilised. Data may be collected manually from the organisations that control or oversee the allocation of frequency usage. Such organisations may be government-controlled or may be authorised by government to control or oversee the allocation of frequency spectrum. The frequency spectrum information may already be held by a variety of organisations, for example a first organisation may have control of a section of the frequency spectrum without using all of that spectrum, thus an overseeing authority may have information indicating that the section of the freguency spectrum has been allocated to that first organisation, but in reality the first organisation may only use part of its allocation for some or all of a given time period and for some or all of a given geographic area. Thus, there is an opportunity for the database to reflect some availability in the frequency spectrum, which according to the overseeing authority would not at present be listed as available.

In order to properly reflect all frequency availability it is likely that a number of separate organisations will need to supply information for the construction of the database.

The information required concerning frequency availability may already held in a machine-readable format on separate computers. For the purposes of the invention all the various sources are collated, together with frequency information, geographic extent of the frequency and time availability/unavailability, to allow a market for the resale/relicensing of the spectrum to be set up.

The frequency availability information may alternatively be collated by direct methods, such as the monitoring of traffic on particular frequencies to check for unused frequencies. The monitoring would be location specific, so a network of direct monitoring could be achieved by any of the well known apparatus and techniques available.

In box 10 of FIG. 1, data is entered into a database 18 (FIG. 2) either to create new entries or to update existing entries via a data entry section 20 (see FIG. 2) of a system for cataloguing the spectrum. The data entry means may be via a website, an e-service interface or by entry into a computer, on a local copy of the database file using the database computer program.

Means 22 (FIG. 2) to query the database 18 are provided to allow querying at box 12 in FIG. 1. The means 22 to query the database 18 may be a website in which particular locations or times can be entered to determine if there are any spare frequencies available. Results are returned (box 14) to the enquirer after comparison of the entered variables and values in the database 18.

A means 24 (FIG. 2) to re-sell the spare spectrum is also included at box 16 in FIG. 1. The re-selling may be achieved by means of an auction, possibly based on a website. The database 18 may be operated by an organisation that re-sells spectrum on behalf of licensors or on behalf of other parties who may own that part of the spectrum. The organisation may be government controlled or may be commercial such as a telecommunications service provider. A further alternative is to re-sell the spare spectrum by means of an electronic market place. Thus re-utilisation of the spare spectrum can be achieved by various methods.

In addition to the above, a means 26 to enforce spectrum usage may also be provided. For example, detector vans may be despatched to monitor usage of the spectrum with a view to preventing or deterring unauthorised use of parts of the radio spectrum.

The method and system described herein advantageously solve the problem of various parts of the spectrum in terms of frequency or geography or other variables being frequently unused to some extent. This unused spectrum can be catalogued by means of the method and system described herein and use can thereby be made of the spare spectrum by re-selling as described above.

Short-term uses for which frequency may be available include temporary events, outside broadcasts, meetings and conferences.

1. A method of monitoring frequency availability for a telecommunications network includes: establishing details of frequency spectrum usage in a database, said details to include one or more of time of use, frequency and geographic area of use; and providing query means for the database, to allow the contents of the database to be queried.

2. A method as claimed in claim 1, in which the details of the spectrum usage additionally include one or more of ownership details of a particular part of the spectrum, licence-holder details of a particular part of the spectrum, planning rules relating to a particular part of the spectrum, a price or prices relating to a particular part of the spectrum.

3. A method as claimed in claim 2, in which said particular part of the spectrum is a part by frequency, a part by geographic area and/or a part by time of use.

4. A method as claimed in claim 1, in which the database is a relational database.

5. A method as claimed in claim 1, in which the database is updated by means of a website interface.

6. A method as claimed in claim 1, in which the query means comprises a user interface, which is operable to allow a user to enter search terms relating to frequency availability.

7. A method as claimed in claim 1, in which the query means is operable to return details of spectrum availability based on the search terms entered.

8. A method as claimed in claim 1, which extends to include a method of re-utilising frequency availability.

9. A method as claimed in claim 8, in which the frequency availability is resold.

10. A method as claimed in either claim 8, in which the database is run and availability resold by a party independent to one or more frequency owners/licence holders.

11. A method as claimed in claim 1, which extends to a method of enforcing spectrum usage, whereby the use of resold frequency availability is monitored.

12. A method as claimed in claim 1, in which the details of spectrum usage are entered as details of frequency in use or as details of frequency not in use.

13. A system for monitoring frequency availability comprises a database containing details of frequency spectrum usage, including at least one of time of use, frequency and geographic area of use; and
database query means, operable to allow details of frequency spectrum usage to be entered and operable to return frequency availability for said entered details of frequency spectrum usage.

14. A system as claimed in claim 13, which also comprises available spectrum purchasing means.

15. A system as claimed in claim 13, which also comprises frequency usage monitoring means.

16. A computer program operable to perform the method of claim 1.

17. A method of monitoring frequency availability for a telecommunications network includes; establishing details of frequency spectrum usage in a database, said details to include one or more of time of use, frequency and geographic area of use; and providing query means for the database, to allow the contents of the database to be queried, in which the details of the spectrum usage additionally include one or more of ownership details of a particular part of the spectrum, licence-holder details of a particular part of the spectrum, planning rules relating to a particular part of the spectrum, a price or prices relating to a particular part of the spectrum, and in which said particular part of the spectrum is a part by frequency, a part by geographic area and/or a part by time of use.

18. A method of providing information concerning frequency availability for a telecommunications network comprises consulting a database of frequency spectrum usage in response to an enquiry from an enquirer and advising the enquirer of frequency availability relating to the enquiry.

19. A method as claimed in claim 18, in which the database consulted is the database referred to in claim 1.

20. A method of constructing a database of frequency availability for a telecommunications network comprises obtaining information of frequency spectrum usage, said information including one or more of time of use, frequency and geographic area of use; and entering said information into a database.

21. A method of brokering frequency availability for a telecommunications network comprises providing information concerning frequency availability on a telecommunications network to a potential purchaser; agreeing a price for the sale/licensing of the frequency availability; and selling/licensing said frequency availability.

22. A method as claimed in claim 21, in which the information concerning frequency availability is obtained from a database as described in claim 1.
